(19) United States
(12) Patent Application Publication
(10) Pub. No.: US 2025/0109359 A1
(43) Pub. Date: Apr. 3, 2025

(54) DRYER SHEET FOR NEUTRALIZING BODY MALODOR FROM WASHED FABRICS

(71) Applicant: Henkel AG & Co. KGaA, Duesseldorf (DE)

(72) Inventors: Daniel Thomas Piorkowski, Fairfield, CT (US); Janet Coope-Epstein, Trumbull, CT (US)

(21) Appl. No.: 18/886,307

(22) Filed: Sep. 16, 2024

Related U.S. Application Data
(60) Provisional application No. 63/586,768, filed on Sep. 29, 2023.

(51) Int. Cl. C11D 3/22; C11D 3/00; C11D 3/30; C11D 3/50; C11D 17/04; C11D 17/06

(52) U.S. Cl. CPC C11D 3/222; C11D 3/001; C11D 3/0068; C11D 3/30; C11D 3/505; C11D 17/047; C11D 17/06; C11D 2111/12

(57) ABSTRACT

A dryer sheet for use during the drying of washed/laundered fabrics is provided. The dryer sheet contains a fabric conditioning composition that includes a highly-branched cyclic dextrin as a fabric malodor removal/inhibition agent. The dryer sheet has been discovered to be highly-effective in removing or eliminating the perception of malodors within washed fabrics.

### CROSS REFERENCE TO RELATED APPLICATION

The present invention claims the benefit of U.S. Provisional Patent Application No. 63/586,768 filed Sep. 29, 2023, the entire content and disclosure of which is incorporated herein by reference.

### BACKGROUND

The present disclosure relates to a dryer sheet for use during the drying of laundered fabrics, and more particularly to a dryer sheet that contains a fabric conditioning composition that includes a highly-branched cyclic dextrin as a fabric malodor removal/inhibition agent. The present disclosure also provides a method of neutralizing malodors from washed/laundered fabrics.

Fabrics (or textiles or clothes) can become hard due to repeated washings. Also, even after washing, fabrics can have an undesirable smell. To restore their softness, improve their scent, or impart other desirable properties, fabrics are often treated by additional processes that are separate from their washing. The treatments are separate because the fabric-treating compositions are often not compatible with the washing detergent. These additional processes can be done, for example, in the washer during an added cycle, or in the dryer when using a solid composition, such as a dryer sheet. For example, it is well known to provide liquid fabric conditioning compositions that soften washed fabrics. Such compositions are typically added to the fabrics in the rinse cycle of the wash process.

Body odor is one of the most prevalent malodors that consumers seek to address by laundering with various detergents, and also by using fabric conditioning compositions. The chemical constituents within body odor, predominantly short-chained fatty acids and mercaptans, persist on fabrics post-wear and may sometimes continue to be perceivable after washing with conventional laundry products. It would therefore be desirable to identify new approaches to further neutralize these malodors to provide enhanced benefits.

### SUMMARY

A dryer sheet for use during the drying of washed/laundered fabrics is provided. The dryer sheet contains a fabric conditioning composition that includes a highly-branched cyclic dextrin as a fabric malodor removal/inhibition agent. The dryer sheet of the present disclosure has been discovered to be highly-effective in removing or eliminating the perception of malodors within washed fabrics.

In embodiments of the present disclosure, the dry sheet comprises a fabric conditioning composition provided on a substrate. The fabric conditioning composition can comprise, consist essentially of, or consist of, a fabric softening agent, a fragrance and a highly-branched cyclic dextrin.

In embodiments of the present disclosure, the highly-branched cyclic dextrin is present in the fabric conditioning composition in an amount of from about 0.05 weight percent to about 10.0 weight percent, based on a total weight of the fabric conditioning composition.

In embodiments of the present disclosure, the highly-branched cyclic dextrin is present in the fabric conditioning composition in an amount of from about 0.5 weight percent to about 5.0 weight percent, based on a total weight of the fabric conditioning composition.

In embodiments of the present disclosure, the highly-branched cyclic dextrin is present in the fabric conditioning composition in an amount of from about 1.0 weight percent to about 3.0 weight percent, based on a total weight of the fabric conditioning composition.

In embodiments of the present disclosure, the highly-branched cyclic dextrin has an average molecular weight of about 100 kilo Daltons to about 5000 kilo Daltons.

In embodiments of the present disclosure, the highly-branched cyclic dextrin has an average molecular weight of about 500 kilo Daltons to about 3000 kilo Daltons.

In embodiments of the present disclosure, the fabric softening agent comprises a quaternary ammonium ester compound.

In embodiments of the present disclosure, the fabric softening agent is present in the fabric conditioning composition in an amount of from about 85 weight percent to about 99.5 weight percent, based on a total weight of the fabric conditioning composition.

In embodiments of the present disclosure, the fabric softening agent is present in the fabric conditioning composition in an amount of from about 92 weight percent to about 99 weight percent, based on a total weight of the fabric conditioning composition.

In embodiments of the present disclosure, the fabric softening agent is present in the fabric conditioning composition in an amount of from about 94 weight percent to about 98 weight percent, based on a total weight of the fabric conditioning composition.

In embodiments of the present disclosure, the fragrance is present in the fabric conditioning composition in an amount from about 0.1 weight percent to about 5.0 weight percent, based on a total weight of the fabric conditioning composition.

In embodiments of the present disclosure, the highly-branched cyclic dextrin is present in the fabric conditioning composition in an amount of from about 1.0 weight percent to about 3.0 weight percent, the fabric softening agent is present in the fabric conditioning composition in an amount of from about 94 weight percent to about 98 weight percent, and the fragrance is present in the fabric conditioning composition in an amount from about 1.0 weight percent to about 2.5 weight percent, based on a total weight of the fabric conditioning composition.

In embodiments of the present disclosure, the substrate comprises a woven material.

The dryer sheet of the present application can be used in a method for neutralizing malodors from washed fabrics. In embodiments, the method comprises introducing a dryer sheet into a dryer containing laundered fabrics, the dryer sheet comprising a fabric conditioning composition provided on a substrate, wherein the fabric conditioning composition comprises a fabric softening agent, a fragrance and a highly-branched cyclic dextrin; and subjecting the fabrics to drying conditions in the presence of the dryer sheet.

### BRIEF DESCRIPTION OF THE DRAWINGS

FIG. 1 (i.e., the sole drawing FIGURE) is process illustration for the preparation of highly-branched cyclic dextrin from amylose.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

Embodiments of the present disclosure are generally directed to a dryer sheet for use in a dryer. The dry sheet comprises a fabric conditioning composition that includes a highly-branched cyclic dextrin as a fabric malodor removal/inhibition agent. In addition to the highly-branched cyclic dextrin, the fabric conditioning composition of the present disclosure includes a fabric softening agent and a fragrance (or perfume). The fabric conditioning composition is applied to a substrate, e.g., a woven or non-woven substrate, to provide a dryer sheet in accordance with the present disclosure.

As initially noted, body odor is one of the most prevalent malodors that consumers seek to avoid having remain on their fabrics post-wear and to remove from fabrics with various laundering agents. Such malodors are predominantly short-chain fatty acid compounds and mercaptan compounds. The dryer sheet of the present disclosure which contains a fabric conditioning composition that includes a highly-branched cyclic dextrin has been discovered to be highly-effective in removing or eliminating the perception of these malodors from post-washed fabrics.

In embodiments of the present disclosure, the dryer sheet that is effective in removing/inhibiting malodor for washed fabrics during the drying process comprises a substrate having a fabric conditioning composition applied thereto. The fabric conditioning composition that is applied to (i.e., loaded on) the substrate comprises, consists essentially of, or consists of, a fabric softening agent, fragrance (i.e., perfume), and a highly-branched cyclic dextrin. Each of the components of the dryer sheet of the present disclosure will now be described in greater detail.

### Highly-Branched Cyclic Dextrin (Also can be Referred to Herein as Cluster Dextrin)

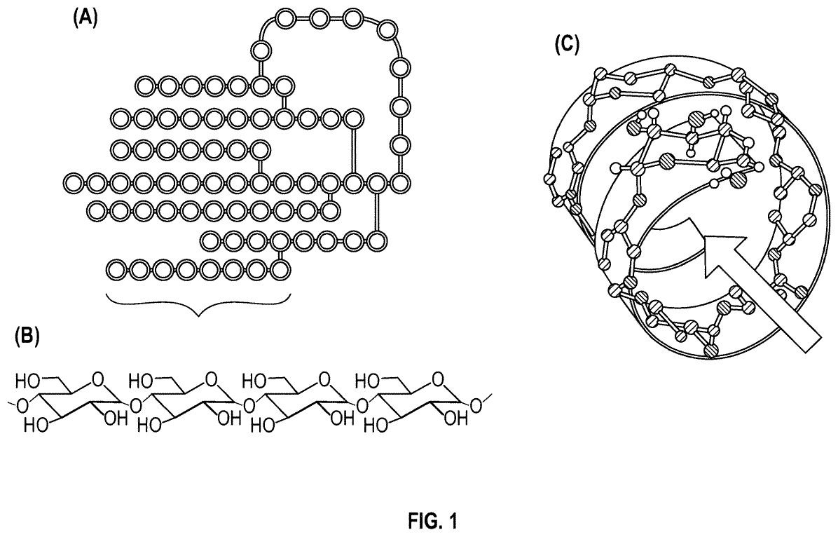

Referring to FIG. 1, dextrin is a polymer of glucose and is produced by a method of enzymatically decomposing a starch, such as amylopectin (for example corn starch). Depending on the enzyme treatment conditions in the manufacturing process, for example, the type and amount of the enzyme, the degree and form of decomposition may be manipulated to produce certain forms, such as branching and molecular weight, of dextrin. Highly-branched cyclic dextrin is one form of dextrin that may be produced in this manner (see portion “A” of FIG. 1), using a cyclization reaction of a branching enzyme (BE,1,4-α-D-glucan: 1,4-α-D-glucan 6-α-D-(1,4-α-D-glucano)-transferase. EC 2.4.1.18). Cyclic dextrin is dextrin characterized in that 6 to 16 glucoses are linked by α-1,4 bonds (see portion “B” of FIG. 1). One example of a cyclic dextrin is α-cyclodextrin, which contains six glucoses. In another example, β-cyclodextrin contains seven glucoses, and in another example, γ-cyclodextrin contains eight glucoses. Without being bound by any theory, the cyclic dextrin can be in the shape of a coil or a helical structure (see portion “C” of FIG. 1). Commercially available highly-branched cyclic dextrin is in the form of a white powder, is soluble in water, and has a loss on drying of less than about 5.5%. In embodiments of the present application, the highly-branched cyclic dextrin is maltodextrin.

The bonds between the glucoses allow cyclic dextrin to have the coil-like or helical-like structure shown in FIG. 1, containing a certain volume of void space. The array of each interior space is formed by oxygen atoms that form glycoside bridges with hydrogen atoms. Therefore, the inner surface becomes very hydrophobic, and the specific shape and physico-chemical properties of the voids have structural features capable of absorbing organic molecules or portions of organic molecules that match the shape of the inner space of the cyclic dextrin. The outside of the cyclic dextrin, however, remains hydrophilic. In this manner, malodors may be entrained within the voids, and effectively removed from the fabric during a drying cycle. Additionally, in the same manner, malodors may be inhibited in fabrics post-wear. In the present disclosure, the highly-branched cyclic dextrin that is used as a fabric malodor removal/inhibition agent can be referred to as cluster dextrin.

The highly-branched cyclic dextrin compounds (i.e., cluster dextrin) employed as a fabric malodor removal/inhibition agent of the fabric conditioning agent that is applied to a substrate in providing a dryer sheet can have an average molecular weight, in embodiments, from about 100 kilo Daltons to about 5000 kilo Daltons, for example from about 500 kilo Daltons to about 3000 kilo Daltons. Moreover, the highly-branched cyclic dextrin can be included within the fabric conditioning composition of the present disclosure, in embodiments, in an amount of from about 0.05 weight percent to about 10.0 weight percent, for example, from about 0.5 weight percent to about 5.0 weight percent, or from about 1.0 weight percent to about 3.0 weight percent. In certain embodiments, the highly-branched cyclic dextrin can be included within the fabric conditioning composition of the present disclosure in an amount from about 0.3 weight percent to about 5.0 weight percent. All weight percentages used herein are by total weight of the fabric conditioning composition, unless otherwise specifically noted.

### Fabric Softening Agent

In order to effect fabric softening properties to the dryer sheet, the fabric conditioning composition of the present disclosure includes at least one fabric softening agent. In many embodiments, the fabric softening agent is a cationic softening agent. The cationic softening is generally one that is able to form a lamellar phase dispersion in water, in particular a dispersion of liposomes. The cationic softening agent is typically a quaternary ammonium ester compound. Suitable quaternary ammonium ester compounds may include materials selected from a monoester quaternary material (“monoester quats”), diester quaternary material (“diester quats”), triester quaternary material (“triester quats”), and mixtures thereof.

Suitable quaternary ammonium ester compounds may be derived from alkanolamines, for example, C₁-C₄ alkanolamines, preferably C₂ alkanolamines (e.g., ethanolamines). The quaternary ammonium ester compounds may be derived from monoalkanolamines, dialkanolamines, trialkanolamines, or mixtures thereof, for example monoethanolamines, diethanolamines, di-isopropanolamines, triethanolamines, or mixtures thereof. The quaternary ammonium ester compounds may be derived from diethanolamines. The quaternary ammonium ester compounds may be derived from di-isopropanolamines. The quaternary ammonium ester compounds may be derived from triethanolamines. The alkanolamines from which the quaternary ammonium ester compounds are derived may be alkylated mono- or dialkanolamines, for example C₁-C₄ alkylated alkanolamines, for example C₁ alkylated alkanolamines (e.g., N-methyl di ethanol amine).

The quaternary ammonium ester compound may include a quaternized nitrogen atom that is substituted, at least in part. The quaternized nitrogen atom may be substituted, at least in part, with one or more C₁-C₃ alkyl or C₁-C₃ hydroxyl alkyl groups. The quaternized nitrogen atom may be substituted, at least in part, with a moiety selected from the group consisting of methyl, ethyl, propyl, hydroxyethyl, 2-hydroxypropyl, 1-methyl-2-hydroxyethyl, poly(C₂-C₃ alkoxy), polyethoxy, benzyl, for example methyl or hydroxyethyl.

The quaternary ammonium ester compound may include compounds according to Formula (I):

{R²₍₄₋ₘ₎—N+—[X—Y—R¹]ₘ} Formula (I)
wherein:
m is 1, 2 or 3, with provisos that, in a given molecule, the value of each m is identical;
each R¹, which may include from 13 to 22 carbon atoms, is independently a linear hydrocarbyl or branched hydrocarbyl group. R¹ may be linear, such as a partially-unsaturated linear alkyl chain;
each R² is independently a C₁-C₃ alkyl or hydroxyalkyl group and/or each R¹ is selected from methyl, ethyl, propyl, hydroxyethyl, 2-hydroxypropyl, 1-methyl hydroxyethyl, poly(C₂-C₃ alkoxy), polyethoxy, benzyl, for example methyl or hydroxyethyl;
each X is independently —(CH₂)ₙ—, —CH₂—CH(CH₃)—, or —CH(CH₃)—CH₂—,
where each n is independently 1, 2, 3 or 4, for example each n may be 2;
each Y is independently —O—(O)C— or —C(O)—O—; and
A is independently selected from the group of chloride, bromide, methyl sulfate, ethyl sulfate, sulfate, and nitrate, for example A is selected from the group of chloride and methyl sulfate, such as methyl sulfate.

The fabric softening agent may be included within the fabric conditioning composition of the present disclosure, in embodiments, in an amount of about 85 weight percent to about 99.5 weight percent, for example, from about 92 weight percent to about 99 weight percent, or from about 94 weight percent to about 98 weight percent.

### Fragrance

In the present disclosure, the terms “fragrance” and “perfume” can be used interchangeably. In embodiments, the fragrance has a melting point that is in the range of from about −100° C. to about 100° C., or from about −80° C. to 80° C., or from about −20° C. to about 50° C., or from about −30° C. to about 20° C. In one aspect, the fragrance has a melting point that is in the range of from about 25° C. to about 400° C., or from about 50° C. to about 380° C., or from about 75° C. to about 350° C., or from about 100° C. to about 330° C.

In one aspect, the fragrance can be an ester, an ether, an aldehyde, a ketone, an alcohol, a hydrocarbon, an essential oil, and a combination thereof.

In one aspect, the fragrance can be, for example, adoxal (2,6,10-trimethyl-9-undecenal), anisaldehyde (4-methoxybenzaldehyde), cymal (3-(4-isopropyl-phenyl)-2-methylpropanal), ethylvanillin, florhydral (3-(3-isopropylphenyl)butanal), helional (3-(3,4-methylenedioxyphenyl)-2-methylpropanal), heliotropin, hydroxycitronellal, lauraldehyde, lyral (3- and 4-(4-hydroxy-4-methylpentyl)-3-cyclohexene-1-carboxaldehyde), methyl nonyl acetaldehyde, lilial (3-(4-tert-butylphenyl)-2-methylpropanal), phenyl acetaldehyde, undecylenaldehyde, vanillin, 2,6,10-trimethyl-9-undecenal, 3-dodecen-1-al, α-n-amylcinnamaldehyde, melonal (2,6-dimethyl-5-heptenal), 2,4-dimethyl-3-cyclohexene-1-carboxaldehyde (triplal), 4-methoxybenzaldehyde, benzaldehyde, 3-(4-tert-butylphenyl)propanal, 2-methyl-3-(para-methoxyphenyl)propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]decylidene-8)butanal, octahydro-4,7-methano-1H-indenecarboxaldehyde, 3-ethoxy-4-hydroxybenzaldehyde, para-ethyl-α,α-dimethylhydrocinnamaldehyde, α-methyl-3,4-(methylenedioxy)hydrocinnamaldehyde, 3,4-methylenedioxybenzaldehyde, α-n-hexylcinnamaldehyde, m-cymene-7-carboxaldehyde, α-methyl phenylacetaldehyde, 7-hydroxy-3,7-dimethyloctanal, undecanal, 2,4,6-trimethyl-3-cyclohexene-1-carboxaldehyde, 4-(3)(4-methyl-3-pentenyl)-3-cyclohexenecarboxaldehyde, 1-dodecanal, 2,4-dimethylcyclohexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanoindane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3,7-dimethyloctanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanoindane-1-carboxaldehyde, 2-methyloctanal, α-methyl-4-(1-methylethyl)benzene acetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methyl nonyl acetaldehyde, hexanal and trans-2-hexenal.

In one aspect, the fragrance can be, for example, methyl β-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), α-damascone, β-damascone, Δ-damascone, iso-damascone, damascenone, methyl dihydrojasmonate, menthone, carvone, camphor, koavone (3,4,5,6,6-pentamethylhept-3-en-2-one), fenchone, α-ionone, μ-ionone, γ-methyl ionone, fleuramone (2-heptylcyclopentanone), dihydrojasmone, cis-jasmone, Iso E Super (1-(1,2,3,4,5,6J,8-octahydro-2,3,8,8-tetramethyl-2-naphthalenyl)ethan-1-one (and isomers)), methyl cedrenyl ketone, acetophenone, methyl acetophenone, para-methoxyacetophenone, methyl β-naphtyl ketone, benzyl acetone, benzophenone, para-hydroxyphenylbutanone, celery ketone (3-methyl-5-propyl-2-cyclohexenone), 6-isopropyldecahydro-2-naphtone, dimethyl octenone, frescomenthe (2-butan-2-ylcyclohexan-1-one), 4-(1-ethoxyvinyl)-3,3,5,5-tetramethylcyclohexanone, methyl heptenone, 2-(2-(4-methyl-3-cyclohexen-1-yl)propyl)cyclopentanone, 1-(p-menthen-6(2)yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)indanone, 4-damascol, dulcinyl(4-(1,3-benzodioxol-5-yl)butan-2-one), Hexalon (1-(2,6,6-trimethyl-2-cyclohexen-1-yl)-1,6-heptadien-3-one), isocyclemone E (2-acetonaphthone-1,2,3,4,5,6,7,8-octahydro-2,3,8,8-tetramethyl), methyl nonyl ketone, methyl cyclocitrone, methyl lavender ketone, orivone (4-tert-amylcyclohexanone), 4-tert-butylcyclohexanone, delphone (2-pentyl cyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan-1-one), 2,4,4,7-tetramethyloct-6-en-3-one and tetrameran (6,10-dimethylundecen-2-one).

In one aspect, the fragrance can comprise, for example, 10-undecen-1-ol, 2,6-dimethylheptan-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol,4-tert-butylcyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, 8-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylat, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol.

In one aspect, the fragrance can be, for example, benzyl acetate, phenoxyethyl isobutyrate, p-tert-butylcyclohexyl acetate, linalyl acetate, dimethyl benzyl carbinyl acetate (DMBCA), phenyl ethyl acetate, benzyl acetate, ethylmethylphenyl glycinate, allyl cyclohexyl propionate, styralyl propionate, benzyl salicylate, cyclohexyl salicylate, floramat, melusat and jasmacyclat.

In one aspect, the fragrance can be, for example, benzyl ethyl ether and ambroxan. The hydrocarbons include mainly terpenes, such as limonene and pinene.

In one aspect, the fragrance can be a mixture of various fragrances, which can be referred to as a perfume or perfume oil. Perfume oils of this kind can also contain natural fragrance mixtures, as are obtainable from plant sources.

In one aspect, the fragrance can be, for example, essential oils such as angelica root oil, anise oil, arnica blossom oil, basil oil, bay oil, champaca blossom oil, citrus oil, silver fir oil, silver fir cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, canaga oil, cardamom oil, cassia oil, pine needle oil, copaiba balsam oil, coriander oil, spearmint oil, caraway oil, cumin oil, labdanum oil, lavender oil, lemongrass oil, lime blossom oil, lime oil, mandarin oil, balm oil, mint oil, musk seed oil, muscatel oil, myrrh oil, clove oil, neroli oil, niaouli oil, olibanum oil, orange blossom oil, orange oil, origanum oil, palmarosa oil, patchouli oil, peru balsam oil, petitgrain oil, pepper oil, peppermint oil, pimento oil, pine oil, rose oil, rosemary oil, sage oil, sandalwood oil, celery oil, spike oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil and ambrettolide, ambroxan, α-amylcinnamaldehyde, anethol, anisaldehyde, anise alcohol, anisol, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerianate, bomeol, bornyl acetate, boisambrene forte, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptine carboxylic acid methyl ester, heptaldehyde, hydroquinone dimethyl ether, hydroxycinnamaldehyde, hydroxycinnamyl alcohol, indol, irone, isoeugenol, isoeugenol methyl ether, isosafrole, jasmone, camphor, carvacrol, carvone, p-cresol methyl ether, cumarin, p-methoxyacetophenone, methyl n-amyl ketone, methyl anthranilic acid methyl ester, p-methyl acetophenone, methyl chavicol, p-methyl quinoline, methyl β-naphthyl ketone, methyl n-nonyl acetaldehyde, methyl n-nonyl ketone, muscone, β-naphthol ethyl ether, β-naphthol methyl ether, nerol, n-nonyl aldehyde, nonyl alcohol, n-octyl aldehyde, p-oxy-acetophenone, pentadecanolide, β-phenyl ethyl alcohol, phenyl acetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, γ-undelactone, vanillin, veratrum aldehyde, cinnmaldehyde, cinnamyl alcohol, cinnamic acid, cinnamic acid ethyl ester, cinnamic acid benzyl ester, diphenyl oxide, limonene, linalool, linalyl acetate and propionate, melusat, menthol, menthone, methyl n-heptenone, pinene, phenyl acetaldehyde, terpinyl acetate, citral, citronellal, and mixtures thereof.

In one aspect, the fragrance can have, for example, a musky scent, a pungent scent, a camphoraceous scent, an ethereal scent, a floral scent, a peppermint scent, or any combination thereof.

In one aspect, the fragrance can comprise methyl formate, methyl acetate, methyl butyrate, ethyl butyrate, isoamyl acetate, pentyl butyrate, pentyl pentanoate, octyl acetate, myrcene, geraniol, nerol, citral, citronellol, linalool, nerolidol, limonene, camphor, terpineol, α-ionone, thujone, benzaldehyde, eugenol, cinnamaldehyde, ethyl maltol, vanillin, anisole, anethole, estragole, thymol, indole, pyridine, furaneol, 1-hexanol, cis-3-hexenal, furfural, hexyl cinnamaldehyde, fructone, hexyl acetate, ethyl methyl phenyl glycidate, dihydrojasmone, oct-1-en-3-one, 2-acetyl-1-pyrroline, 6-acetyl-2,3,4,5-tetrahydropyridine, γ-decalactone, γ-nonalactone, Δ-octalone, jasmine lactone, massoia lactone, wine lactone, sotolon, grapefruit mercaptan, methanthiol, methyl phosphine, dimethyl phosphine, nerolin, 2,4,6-trichloroanisole, or any combination thereof.

In one aspect, the fragrance can comprise a linear terpene, a cyclic terpene, an aromatic compound, a lactone, a thiol, or any combination thereof.

Other art-known fragrances, or any fragrance commercially available from a fragrance supplier (for example, Firmenich, Givaudan, International Flavors and Fragrances (IFF), Symriseetc), or combinations of such fragrances, may also suitably be used in the fabric conditioning composition of the present disclosure.

In one aspect, the fragrance can be a fragrance precursor. “Fragrance precursor” refers to compounds which only release the actual fragrance following chemical conversion/separation, for example, when exposed to light or other environmental conditions, such as pH, temperature, etc. Compositions of this kind are often referred to as pro-fragrances.

In one aspect, the fragrance can be encapsulated, for example, in a microcapsule or a nanocapsule. The microcapsules and nanocapsules can be water-soluble or water-insoluble. In one aspect, all of the fragrance is encapsulated. Examples of encapsulated fragrances are described in, for example, U.S. Pat. Nos. 6,024,943, 6,056,949, 6,194,375, 6,458,754 and 8,426,353, and US 2011/0224127 A1, each of which is incorporated by reference in its entirety. In one aspect, the fragrance can be a free fragrance, a fragrance precursor, or an encapsulated fragrance, or any combination thereof.

In the present disclosure, the fragrance component is contained in the fabric conditioning composition in an amount of from about 0.1 weight percent to about 5.0 weight percent, for example from about 0.5 weight percent to about 3.0 weight percent, or from about 1.0 weight percent to about 2.5 weight percent.

### Optional Components

The fabric conditioning composition of the present disclosure may optionally include one or more other components. Such components include co-softeners (such as fatty esters, and fatty N-oxides) preservatives (e.g., bactericides). pH buffering agents, fragrance carriers, biocides, enzymes, anti-shrinking agents, anti-wrinkle agents, anti-oxidants, anti-corrosion agents, drape imparting agents, anti-static agents, ironing aids, and dyes, among others known in the art. Such optional ingredients may be included in amounts, respectively, of from about 0.0001 weight percent to about 1.0 weight percent, for example.

### Dryer Sheet Substrate

The substrate that is employed in the present disclosure may be any substrate known in the art, including, for example, non-woven and woven materials, open-cell rubber or plastic foam sheets, and sheets of cellulose fibers, as long as the substrate is capable of holding the fabric conditioning composition of the present disclosure. The substrate is preferably a woven material. The woven material can include conventional materials, such as polyester, acrylics, rayon, or cotton.

### Dryer Sheet Formation

Application of the fabric conditioning composition of the present disclosure to the substrate can include first providing a fabric softening agent in molten form, and thereafter adding the molten fabric softening agent to a blend including at least the highly-branched cyclic dextrin and the fragrance. The blend can also include one or more of the optional components mentioned above. The molten fabric softening agent can be formed by heating the fabric softening agent above the melting temperature (i.e., a temperature at which the compound converts from a solid form to a liquid form) of the fabric softening agent that is employed. The addition of the molten fabric softening agent can be a metered addition. Also, and during the addition of the molten fabric softening agent to the blend, continuous stirring can be employed. The resultant fabric conditioning composition including the fabric softening agent, highly-branched cyclic dextrin and the fragrance is then applied to a substrate as described above. In embodiments of the present disclosure, the resultant fabric conditioning composition including the fabric softening agent in molten form, fragrance and highly-branched cyclic dextrin can be cooled below the melting point of the fabric softening agent to avoid fabric softening agent flash off during application of the fabric conditioning composition to the substrate. In other embodiments of the present disclosure, the resultant fabric conditioning composition including the fabric softening agent in molten form, fragrance and highly-branched cyclic dextrin can be applied directly to the substrate without performing any cooling process.

Application of the fabric conditioning composition of the present disclosure to the substrate may occur using any device which forces the fabric conditioning composition of the present disclosure into the substrate or allows the fabric conditioning composition of the present disclosure to flow on and into the substrate. Examples of application equipment include standard coating equipment, slot applicators, various types of printing equipment, padding equipment, and spraying equipment. The substrate is then carried by a supporting device through a drying device and processed into sheets or wound into rolls. Examples of supporting devices include rollers, belts, and clip and pin frames.

### Dryer Sheet Usage

The dryer sheet of the present disclosure can be used in any conventional cloth drying apparatus (i.e., a tumble dryer). The dryer sheet of the present disclosure can be added to a dryer containing a load of washed/laundered fabrics that need to be dried. The addition of the dryer sheet of the present disclosure to the dryer can occur anytime during the drying process. Preferably, it is added during the beginning of the drying process. Drying conditions that can be used are conventional drying conditions that are associated with conventional cloth drying apparatus. The dryer sheet of the present disclosure effects a soft feel and a pleasant fragrance to the dried fabrics. Moreover, and due to the presence of the high-branched cyclic dextrin component, the dryer sheet of the present disclosure neutralizes and even eliminates malodor that is associated with washed fabrics.

Examples have been set forth below for the purpose of further illustrating the present disclosure. The scope of the present disclosure is not limited to any of the examples set forth herein.

### Example

Two fabric conditioning compositions based on Formula 1 and Formula 2 shown in Table 1 were prepared; the term “formula” here means formulation. Formula 1 and Formula 2 of Table 1 are identical in composition except that Formula 2 included highly-branched cyclic dextrin as described herein, while the highly-branched cyclic dextrin was omitted from Formula 1. Formula 1 is a comparative example (namely CE1), while formula 2 is an example in accordance with an embodiment of the present disclosure.

TABLE 1

| | Wt % of | Wt % of |
|---|---|---|
| | Formula 1 | Formula 2 |
| Component | (Comparative) | (Inventive) |
| Quaternary Ammonium | 98 | q/s to 100 |
| fabric softening agent | | |
| Fragrance | 2.0 | 2.0 |
| Highly-branched cyclic | N/A | 0.3 to 5.0 |
| dextrin | | |

Each of Formulas 1 and 2 were then applied to a substrate and formed into a dryer sheet. Notably, and for Formula 1, a fabric conditioning composition was prepared by adding the quaternary ammonium compound in molten form to the fragrance thereafter applying that composition to the substrate. In the case of Formula 2, a fabric conditioning composition was prepared by adding the quaternary ammonium compound in molten form to a blend of the fragrance and the highly-branched cyclic dextrin and thereafter applying that composition to the substrate.

In dry applications using equivalent drying conditions and fabrics having equivalent malodor, the dryer sheet made from Formula 2 above provided enhanced malodor reduction in fabrics that were dried with that dryer sheet as compared to fabrics that were dried with the dryer sheet made from Formula 1 above.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A dryer sheet comprising:
a fabric conditioning composition provided on a substrate, wherein the fabric conditioning composition comprises a fabric softening agent, a fragrance and a highly-branched cyclic dextrin.

2. The dryer sheet of claim 1, wherein the highly-branched cyclic dextrin is present in the fabric conditioning composition in an amount of from about 0.05 weight percent to about 10.0 weight percent, based on a total weight of the fabric conditioning composition.

3. The dryer sheet of claim 1, wherein the highly-branched cyclic dextrin is present in the fabric conditioning composition in an amount of from about 0.5 weight percent to about 5.0 weight percent, based on a total weight of the fabric conditioning composition.

4. The dryer sheet of claim 1, wherein the highly-branched cyclic dextrin is present in the fabric conditioning composition in an amount of from about 1.0 weight percent to about 3.0 weight percent, based on a total weight of the fabric conditioning composition.

5. The dryer sheet of claim 1, wherein the highly-branched cyclic dextrin has an average molecular weight of about 100 kilo Daltons to about 5000 kilo Daltons.

6. The dryer sheet of claim 1, wherein the highly-branched cyclic dextrin has an average molecular weight of about 500 kilo Daltons to about 3000 kilo Daltons.

7. The dryer sheet of claim 1, wherein the fabric softening agent comprises a quaternary ammonium ester compound.

8. The dryer sheet of claim 1, wherein the fabric softening agent is present in the fabric conditioning composition in an amount of from about 85 weight percent to about 99.5 weight percent, based on a total weight of the fabric conditioning composition.

9. The dryer sheet of claim 1, wherein the fabric softening agent is present in the fabric conditioning composition in an amount of from about 92 weight percent to about 99 weight percent, based on a total weight of the fabric conditioning composition.

10. The dryer sheet of claim 1, wherein the fabric softening agent is present in the fabric conditioning composition in an amount of from about 94 weight percent to about 98 weight percent, based on a total weight of the fabric conditioning composition.

11. The dryer sheet of claim 1, wherein the fragrance is present in the fabric conditioning composition in an amount from about 0.1 weight percent to about 5.0 weight percent, based on a total weight of the fabric conditioning composition.

12. The dryer sheet of claim 1, wherein the highly-branched cyclic dextrin is present in the fabric conditioning composition in an amount of from about 1.0 weight percent to about 3.0 weight percent, the fabric softening agent is present in the fabric conditioning composition in an amount of from about 94 weight percent to about 98 weight percent, and the fragrance is present in the fabric conditioning composition in an amount from about 1.0 weight percent to about 2.5 weight percent, based on a total weight of the fabric conditioning composition.

13. The dryer sheet of claim 1, wherein the substrate comprises a woven material.

14. A method of neutralizing malodors from washed fabrics, the method comprising:
introducing a dryer sheet into a dryer containing laundered fabrics, the dryer sheet comprising a fabric conditioning composition provided on a substrate, wherein the fabric conditioning composition comprises a fabric softening agent, a fragrance and a highly-branched cyclic dextrin; and
subjecting the fabrics to drying conditions in the presence of the dryer sheet.

15. The method of claim 14, wherein the highly-branched cyclic dextrin is present in the fabric conditioning composition in an amount of from about 0.05 weight percent to about 10.0 weight percent, based on a total weight of the fabric conditioning composition.

16. The method of claim 14, wherein the highly-branched cyclic dextrin is present in the fabric conditioning composition in an amount of from about 0.5 weight percent to about 5.0 weight percent, based on a total weight of the fabric conditioning composition.

17. The method of claim 14, wherein the highly-branched cyclic dextrin is present in the fabric conditioning composition in an amount of from about 1.0 weight percent to about 3.0 weight percent, based on a total weight of the fabric conditioning composition.

18. The method of claim 14, wherein the highly-branched cyclic dextrin has an average molecular weight of about 100 kilo Daltons to about 5000 kilo Daltons.

19. The method of claim 14, wherein the highly-branched cyclic dextrin has an average molecular weight of about 500 kilo Daltons to about 3000 kilo Daltons.

20. The method of claim 1, wherein the highly-branched cyclic dextrin is present in the fabric conditioning composition in an amount of from about 1.0 weight percent to about 3.0 weight percent, the fabric softening agent is present in the fabric conditioning composition in an amount of from about 94 weight percent to about 98 weight percent, and the fragrance is present in the fabric conditioning composition in an amount from about 1.0 weight percent to about 2.5 weight percent, based on a total weight of the fabric conditioning composition.
